(19) United States
(12) Patent Application Publication
(10) Pub. No.: US 2012/0000803 A1
(43) Pub. Date: Jan. 5, 2012

(54) TOOL BOX WITH ANTI-SLIP SURFACE

(76) Inventor: WEI-CHUN CHIU, Taichung County (TW)

(21) Appl. No.: 12/960,333

(22) Filed: Dec. 3, 2010

(30) Foreign Application Priority Data
Jul. 1, 2010 (TW) 099212561

(51) Int. Cl. B25H 3/02

(52) U.S. Cl. 206/349

(57) ABSTRACT

A tool box includes a plastic case formed by way of blow molding and a flexible piece is integrally formed on an outside of the plastic case during processes of the blow molding. The flexible piece is connected to an inside of a female mold and the melted plastic material is inflated and matches the insides of the male and female molds. The flexible piece is securely connected to the melted plastic material high temperature and pressure so that flexible piece and the melted plastic material are not separated. After the tool box is formed, the tool box includes an anti-slip and flexible piece on the outside thereof.

### FIELD OF THE INVENTION

The present invention relates to a tool box, and more particularly, to a tool box made by way of blow molding and an anti-slip piece is formed on the outside of the tool box.

### BACKGROUND OF THE INVENTION

A conventional blow molding for making a plastic tool box comprises the following steps which are:

1. Blowing the plastic material. The melted thermo-plastic material is ejected from a nozzle and air is introduced into the material to inflate the material. The material is blown and the bottom of the material is sealed as a pocket.

2. Locating the material between the male and female molds. The male and female molds clamp the inflated material and cut the top of the inflated material.

3. Matching the material to the insides of the male and female molds. Air is continuously introduced into the inflated material by using a tube in the male mold to ensure that the material is tightly matched with the insides of the male and female molds.

4. Cooling the material. The material in the male and female molds is cooled and solidified by the cooling paths in the male and female molds.

5. Removing the product from the male and female molds. The male and female molds are separated from each other to obtain the product.

The material generally is Polyethylene (PE) which becomes stiff and hard after being solidified. A tool tray is installed to the tool box and tools are received in the recesses of the tool tray and make the tool box heavy. The tool box includes rough surface compared with some tables treated with mirror paint finish, so that when moving the tool box, scratches could be left on the surface of the table.

Besides, when the surface on which the tool box is put at an angle, the tool box may slip and cannot be positioned.

The present invention intends to provide a tool box made by way of blow molding and an anti-slip piece is integrally formed on the outside of the tool box during the processes of the blow molding.

### SUMMARY OF THE INVENTION

The present invention relates to a tool box and includes a plastic case formed by way of blow molding and a flexible piece is integrally formed on an outside of the plastic case during processes of the blow molding. The flexible piece is connected to an inside of a female mold and the melted plastic material is inflated and matches the insides of the male and female molds. The flexible piece is securely connected to the melted plastic material so that the tool box includes an anti-slip and flexible piece on the outside thereof.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the male mold, the female mold and the flexible piece in the initial stage of the blow molding processes for making the tool box of the present invention;

FIG. 2 is a cross sectional view to show the male mold, the female mold, the flexible piece and the melted material of the blow molding processes for making the tool box of the present invention;

FIG. 3 is a cross sectional view to show the male mold, the female mold and the melted material located between the male and female molds, and the flexible piece is positioned at the inside of the female mold of the blow molding processes for making the tool box of the present invention;

FIG. 4 shows that the inflated material is cut and matched to the insides of the male and female molds;

FIG. 5 shows that the flexible piece is formed on the outside of the tool box of the present invention;

FIG. 6 is a cross sectional view to show that the flexible piece is formed on the outside of the tool box of the present invention, and

FIG. 7 is another embodiment to show the positioning of the flexible piece on the inside of the female mold.

### DETAILED DESCRIPTION OF THE PREFERRED EMBODIMENT

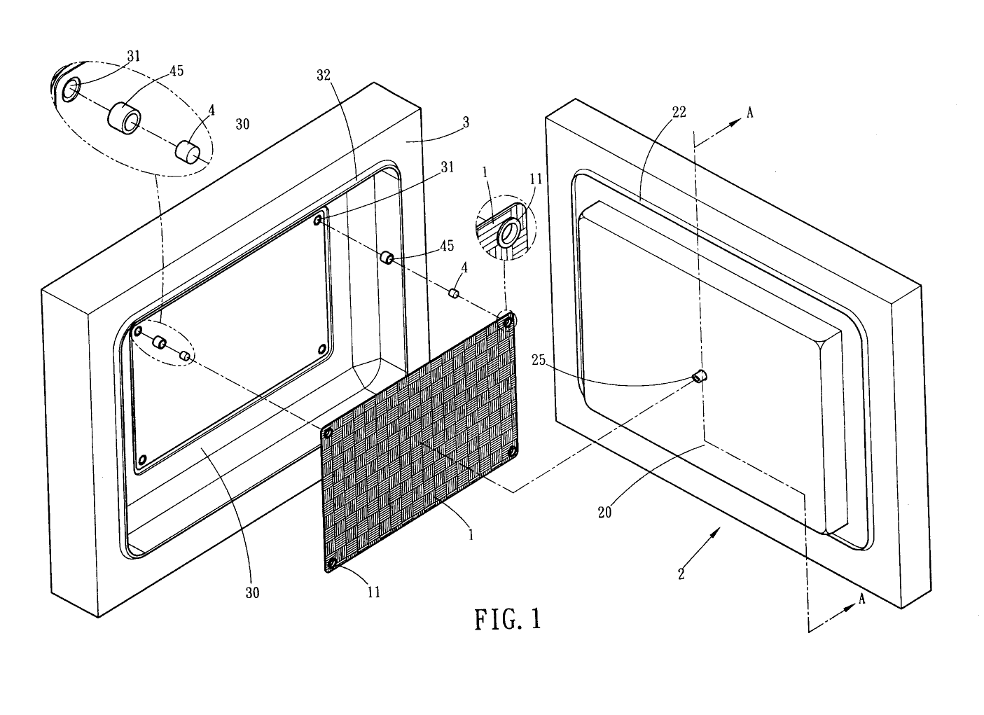

Referring to FIGS. 1 to 6, the blow molding processes for making the tool box of the present invention comprises the following steps:

1. Cutting. The flexible piece 1 is cut to desired shape and size by mold or knife (not shown).

2. Positioning. The flexible piece 1 includes positioning members 11 (metallic material or non-metallic material) located at four corners thereof, or the flexible piece 1 includes holes 10 in the four corners and positioning members 11 are engaged with the holes 10. The female mold 3 includes recesses 31 defined therein and the positioning members 11 are inserted into the recesses 31 of the female mold 3 so as to position the flexible piece 1. The flexible piece 1 is made by flexible material such as leather (artificial or real animal leather) or fabric. The thickness of the positioning members 11 is thicker than the thickness of the flexible piece 1. The positioning members 11 are connected to corners of the flexible piece 1 or the opposite sides of the flexible piece 1. The positioning members 11 is connected to the flexible piece 1 by different ways such as mounting to an object, snapped between male and female parts, threaded or by using third members to secure the positioning members 11 to the flexible piece 1.

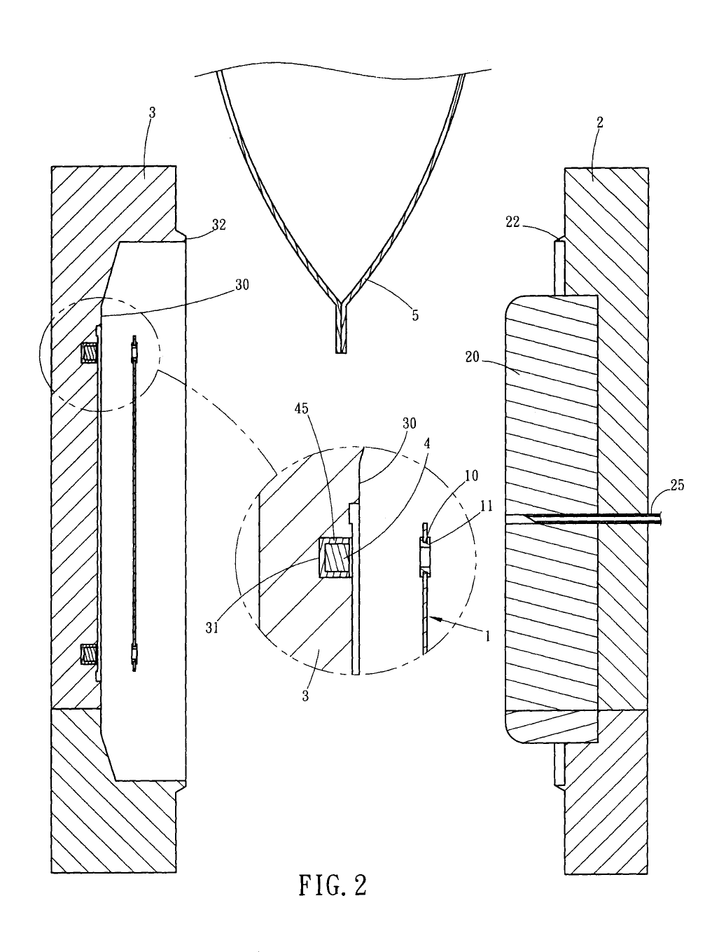

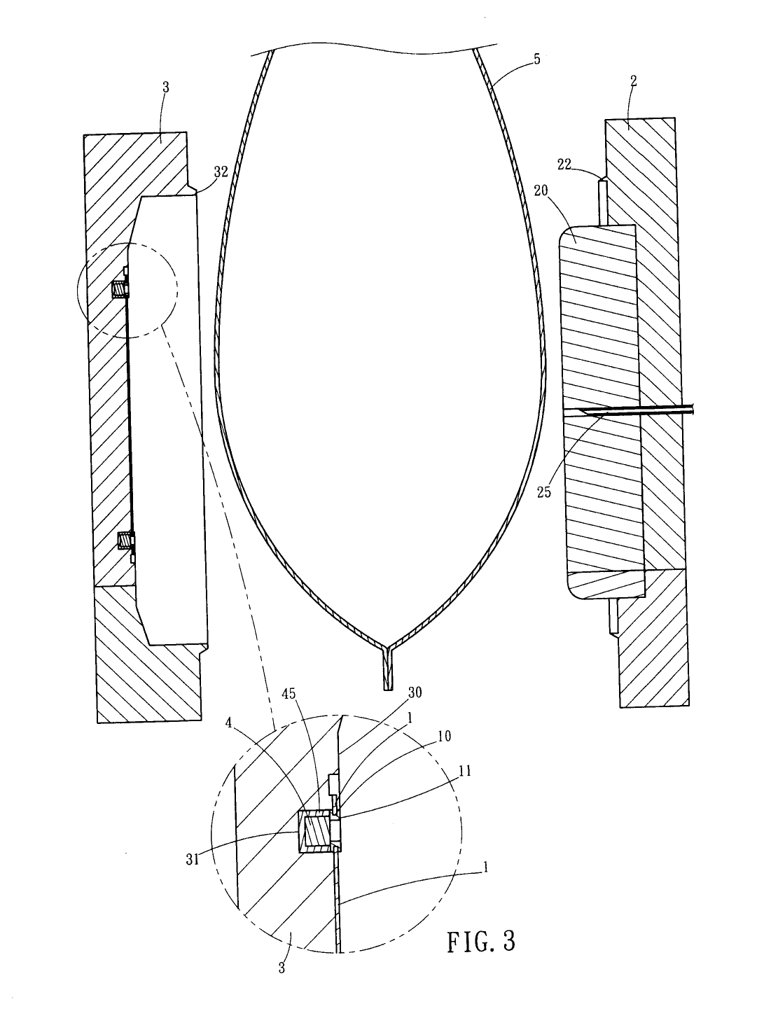

3. Positioning the flexible piece to the female mold. Align the positioning members 11 on the corners of the flexible piece 1 with the magnetic members 4 on the inside 30 of the female mold 3 as shown in FIGS. 1 and 2, the positioning members 11 made of metallic material are attracted by the magnetic members 4 so that the flexible piece 1 is stretched and snugly attached onto the inside 30 of the female mold 3 as shown in FIG. 3. Each of the magnetic members 4 is mounted by a separation member 45 which is located between an inside of the recess 31 and the magnetic member 4. The recess 31 can be a circular recess or threaded recess. The separation members 45 can be cylindrical members or threaded cylindrical members, and the separation members 45 preferably are made of Aluminum or non-ferrous material.

4. Introducing melted material. The melted material 5 is ejected from a nozzle (not shown) and air is introduced into the melted material 5 and the bottom of the melted material 5 is sealed so that the melted material 5 is inflated as shown in FIG. 3.

5. Clamping. The male and female molds 2, 3 clamps the melted material 5 and two respective cutting portions 22, 32 on the male and female molds 2, 3 cut the top portion of the inflated melted material 5 and seals the top portion so that the inflated melted material 5 is located between the male and female molds 2, 3.

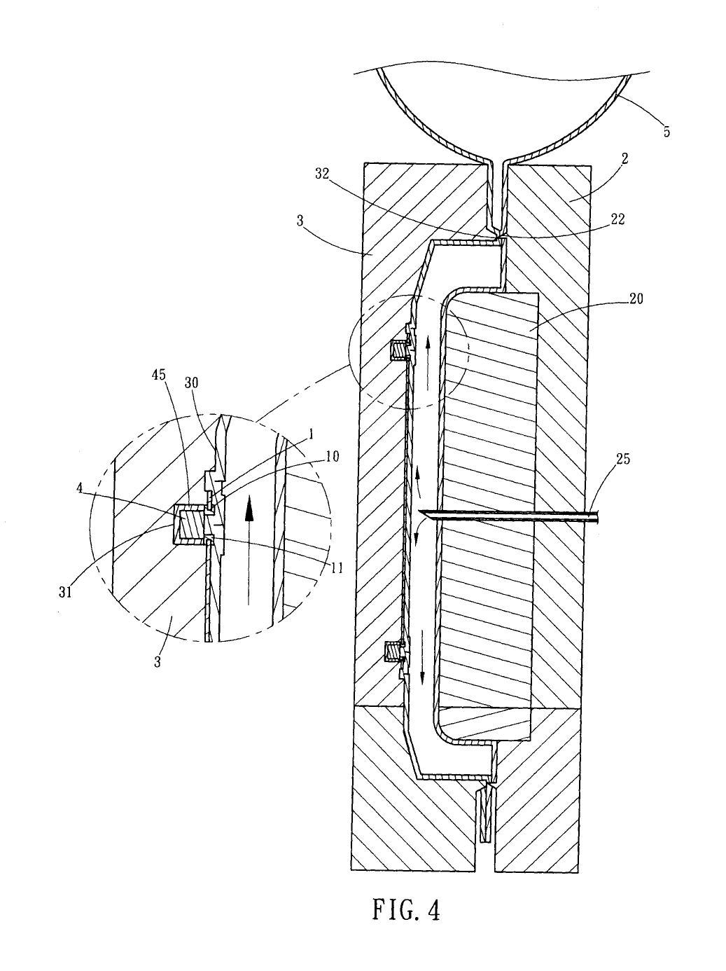

6. Blowing air into the inflated melted material 5. Air is introduced into the inflated melted material 5 via a tube 25 extending through the male mold 2 so that the inflated melted material 5 is matched to the insides of the male and female molds 2, 3 by the pressure until the inflated melted material 5 is completely matched to the insides of the male and female molds 2, 3 as shown in FIG. 4.

7. Connecting the flexible piece 1. The inflated melted material 5 presses the flexible piece 1 and is connected with the flexible piece 1 as shown in FIG. 4.

8. Cooling the melted material 5. The melted material 5 is cooled and solidified by the cooling paths in the male and female molds 2, 3.

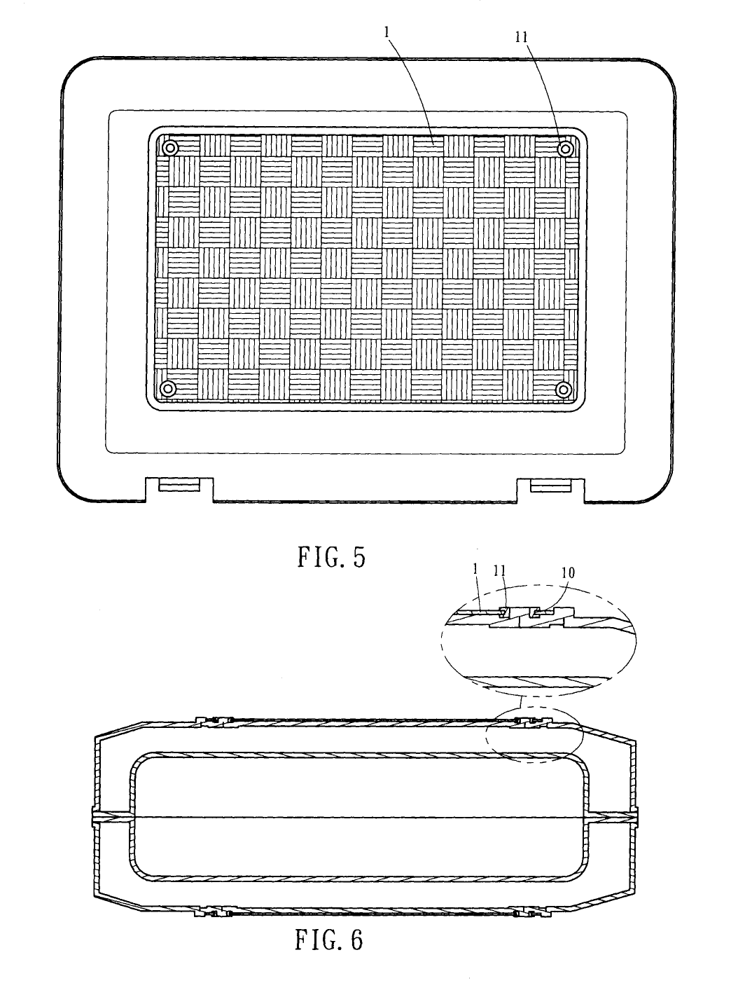

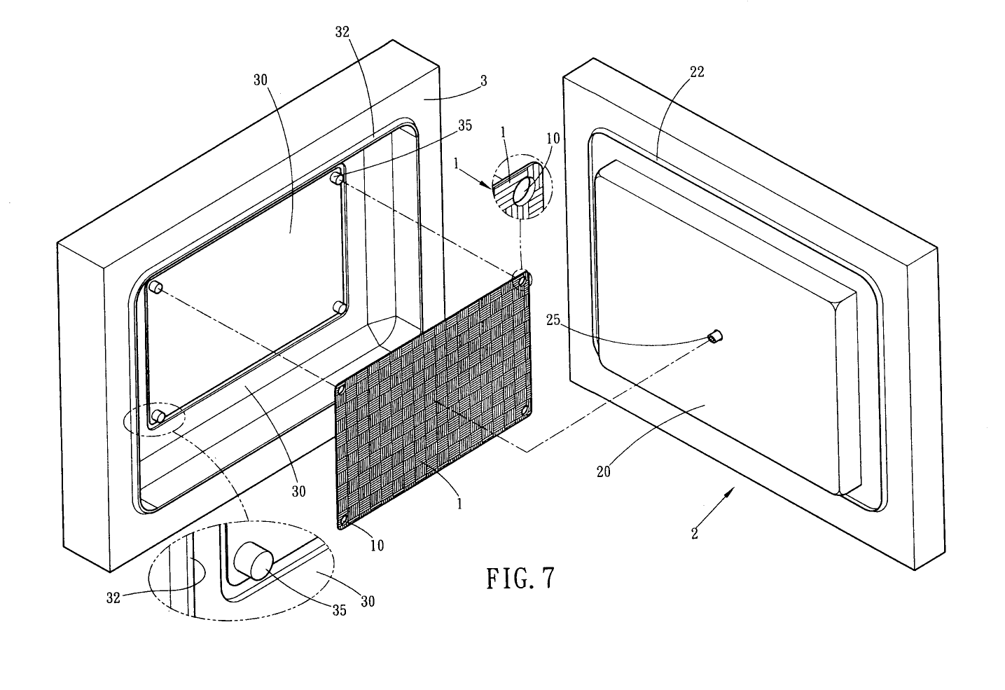

9. Obtaining the product. The male and female molds 2, 3 are separated from each other and the push members (not shown) of the female mold 3 push the solidified material which is connected with the flexible piece 1 out from the female mold 3 to obtain the product, the tool box, with the flexible piece 1 on the outside of the tool box as shown in FIGS. 5 and 6.

The flexible piece 1 has to be stretched and the positioning member 11 on the corners of the flexible piece 1 are attracted to the magnetic members 4 of the female mold 3. The melted material 5 is inflated and connected to the flexible piece 1 so that the flexible piece 1 and the melted material 5 do not separate from each other by any impact. The flexible piece 1 prevents the tool box from scratching the table surface and from slipping on smooth surface.

FIG. 7 shows the second embodiment of the present invention wherein the flexible piece 1 includes holes 10 defined in corners or the opposite sides thereof. The inside 30 of the female mold 3 includes protrusions 35 so that the holes 10 are mounted to the protrusions 35 to position the flexible piece 1.

While we have shown and described the embodiment in accordance with the present invention, it should be clear to those skilled in the art that further embodiments may be made without departing from the scope of the present invention.

What is claimed is:

1. A tool box comprising:
a plastic case formed by way of blow molding and a flexible piece integrally formed on an outside of the plastic case during processes of the blow molding.

2. The tool box as claimed in claim 1, wherein the flexible piece is connected to an inside of a female mold which is cooperated with a male mold, a melted plastic material is located between the male and female molds and blown by air, the melted plastic material is inflated and matches the insides of the male and female molds, the flexible piece is securely connected to the melted plastic material.

3. The tool box as claimed in claim 2, wherein the flexible piece includes holes and positioning members are engaged with the holes.

4. The tool box as claimed in claim 3, wherein the positioning members are made of metallic material and attracted to magnetic members connected to the inside of the female mold.

5. The tool box as claimed in claim 3, wherein the female mold includes recesses defined therein and the positioning members are inserted into the recesses of the female mold so as to position the flexible piece.

6. The tool box as claimed in claim 4, wherein the female mold includes recesses defined therein and the magnetic members are located in the recesses.

7. The tool box as claimed in claim 6, wherein each of the magnetic members is mounted by a separation member which is located between an inside of the recess and the magnetic member.

8. The tool box as claimed in claim 6, wherein the positioning members are connected to corners of the flexible piece or the opposite sides of the flexible piece.

9. The tool box as claimed in claim 6, wherein the flexible piece includes holes defined in corners of the flexible piece or the opposite sides of the flexible piece, the inside of the female mold includes protrusions which extend through the holes.

10. The tool box as claimed in claim 5, wherein the female mold includes recesses defined therein and the magnetic members are located in the recesses.

11. The tool box as claimed in claim 10, wherein each of the magnetic members is mounted by a separation member which is located between an inside of the recess and the magnetic member.

12. The tool box as claimed in claim 10, wherein the positioning members are made of metallic material and located at corners of the flexible piece or opposite sides of the flexible piece.

13. The tool box as claimed in claim 10, wherein the flexible piece includes holes defined in corners of the flexible piece or the opposite sides of the flexible piece, the inside of the female mold includes protrusions which extend through the holes.

14. The tool box as claimed in claim 12, wherein the flexible piece includes holes defined in corners of the flexible piece or the opposite sides of the flexible piece, the inside of the female mold includes protrusions which extend through the holes.
